(19) United States
(12) Patent Application Publication
(10) Pub. No.: US 2017/0127249 A1
(43) Pub. Date: May 4, 2017

(54) Method and On-Vehicle Terminal for Communication with Vehicles in Vehicle Fleet

(71) Applicant: Leauto Intelligent Technology (BEIJING) Co.Ltd, Beijing (CN)

(72) Inventors: Dan LI, Beijing (CN); Yong XU, Beijing (CN); KunSheng CHEN, Beijing (CN); Yu ZOU, Beijing (CN); WenRui LI, Beijing (CN); Peng LIU, Beijing (CN); Wei LIN, Beijing (CN)

(73) Assignee: Leauto Intelligent Technology (BEIJING) Co.Ltd, Beijing (CN)

(21) Appl. No.: 14/977,610

(22) Filed: Dec. 21, 2015

(30) Foreign Application Priority Data
Nov. 2, 2015 (CN) 201510735981.9

(51) Int. Cl. H04W 4/08; H04W 64/00; H04W 72/12

(52) U.S. Cl. CPC H04W 4/08; H04W 72/1278; H04W 64/006; H04W 84/005

(57) ABSTRACT

The present disclosure provides a method and on-vehicle terminal for communicating with vehicles in vehicle fleet. In the present embodiment, in a vehicle fleet including at least a first, a second, and a third vehicles, the first vehicle may exhibit shared information if it is confirmed that the shared information is not included in a list of exhibited information, after the first vehicle receives the shared information transmitted by the second vehicle in the vehicle fleet via V2X communication, and the first vehicle further forwards the shared information to the third vehicle, if the first vehicle finds the third vehicle different from the second vehicle in the vehicle fleet after searching for the third vehicle in a V2X communication range so that the third vehicle may exhibit the shared information. Therefore, the present disclosure may enable the voice or other data and/or information to be shared in the vehicle fleet.

### CROSS-REFERENCE TO RELATED APPLICATIONS

This application claims priority to Chinese Patent Application No. 201510735981.9, with the title of “ [symbol] [symbol] [symbol] ” (METHOD AND ON-VEHICLE TERMINAL FOR COMMUNICATING WITH VEHICLES IN VEHICLE FLEET), filed on Nov. 2, 2015, which is hereby incorporated by reference in its entirety.

### TECHNICAL FIELD

The present disclosure relates to communication technology, and more particularly to a method and on-vehicle terminal for communication with vehicles in vehicle fleet.

### BACKGROUND

During traveling of vehicle fleet, if members of the vehicle fleet need to perform communication by voice, the present method is to use intercoms to perform multi-party communication. The transmission range of an intercom may generally be 2 to 5 kilometers, and respective members in the vehicle fleet may receive and transmit voice only by setting their respective intercoms to the same frequency band, so as to perform the voice communication among members of vehicle fleet.

However, at the same time, due to the half duplex communication mode of intercom, when one member is transmitting voice, other members may only receive voices rather than transmitting voices. Therefore, when using the intercoms, there is only one member being capable of talking at one time among members. If members of the vehicle fleet need to make discussion on the route, it is inconvenient and inefficient for members to discuss with intercoms. That is to say, such method of using intercoms may not meet the need for performing teleconference among members.

In other words, in the related art, with the manner that members in vehicle fleet may perform voice communication via intercoms, the efficiency of communication may be low due to the fact that only one member can speak at one time.

### SUMMARY

The embodiments of the present disclosure provide a method and on-vehicle terminal for communication with vehicles in vehicle fleet, which may solve the technical problem that with the manner that members in vehicle fleet may perform voice communication via intercoms, the efficiency of communication may be low due to the fact that only one member can speak at one time.

To achieve the above technical objects, the embodiments of the present disclosure provide the following technical solutions:

In the first aspect, the embodiment of the present disclosure provides a method for communication with vehicles in vehicle fleet including: receiving a shared information transmitted by a second vehicle in the vehicle fleet; exhibiting the shared information and adding the shared information to a list of exhibited information, if the shared information is not included in the list of exhibited information; searching for a vehicle different from the second vehicle in the vehicle fleet in the V2X (Vehicle to X) communication range; and forwarding the shared information to the vehicle different from the second vehicle in the vehicle fleet, if the vehicle different from the second vehicle in the vehicle fleet is found.

In the second aspect, the embodiment of the present disclosure provides an on-vehicle terminal, which is mounted on a first vehicle in the vehicle fleet, and is configured to perform communication between the first vehicle and other vehicles in the vehicle fleet, the on-vehicle terminal includes: a receiving module configured to receive a shared information transmitted by a second vehicle in the vehicle fleet; an exhibiting module configured to exhibit the shared information, if it is determined that the shared information is not included in a list of exhibited information; a searching module configured to search a vehicle different from the second vehicle in the vehicle fleet in the V2X (Vehicle to X) communication range; and a transmission module configured to forward the shared information to the vehicle different from the second vehicle in the vehicle fleet, if the vehicle different from the second vehicle in the vehicle fleet is found.

In the third aspect, the embodiment of the present disclosure provides an on-vehicle terminal, which is mounted on a first vehicle in the vehicle fleet, and is configured to perform communication between the first vehicle and other vehicles in the vehicle fleet, comprising: one or more processors; a memory; and one or more programs stored in the memory and configured to perform operations when executed by the one or more processors, wherein the operations comprise: receiving shared information transmitted by a second vehicle in the vehicle fleet; exhibiting the shared information and adding the shared information to a list of exhibited information, if it is determined that the shared information is not included in the list of exhibited information; searching for a vehicle different from the second vehicle in the vehicle fleet in a V2X (Vehicle to X) communication range; and forwarding the shared information to the vehicle different from the second vehicle in the vehicle fleet, if the vehicle different from the second vehicle in the vehicle fleet is found.

The embodiment of the present disclosure may enable the voice or other data and/or information to be shared in the vehicle fleet by exhibiting the shared information if it is confirmed that a shared information is not included in a list of exhibited information, after the first vehicle receives the shared information transmitted by a second vehicle in the vehicle fleet via V2X communication, and further forwarding the shared information to a vehicle different from the second vehicle in the vehicle fleet if the first vehicle found such vehicle after searching such vehicle in a V2X communication range so that such vehicle may exhibit the shared information. In addition, the present disclosure may solve the technical problem that with the manner that members in vehicle fleet may perform voice communication via intercoms, the efficiency of communication may be low due to the fact that only one member can speak at one time by the fact that the V2X communication may receive data while transmitting data.

### BRIEF DESCRIPTION OF THE DRAWINGS

FIG. 1 is a flowchart of a method for communication with vehicles in vehicle fleet provided by the first embodiment of the present disclosure;

FIG. 2 is a view of a possible relative position relationship view of vehicles in vehicle fleet;

FIG. 3 is a view of another possible relative position relationship view of vehicles in vehicle fleet;

FIG. 4 is a flowchart of another method for communication with vehicles in vehicle fleet provided by the second embodiment of the present disclosure;

FIG. 5 is a view of the structure of an on-vehicle terminal provided by the third embodiment of the present disclosure;

FIG. 6 is a view of the structure of another on-vehicle terminal provided by the fourth embodiment of the present disclosure; and

FIG. 7 is a structural diagram of another device for monitoring a vehicle key provided by the present disclosure.

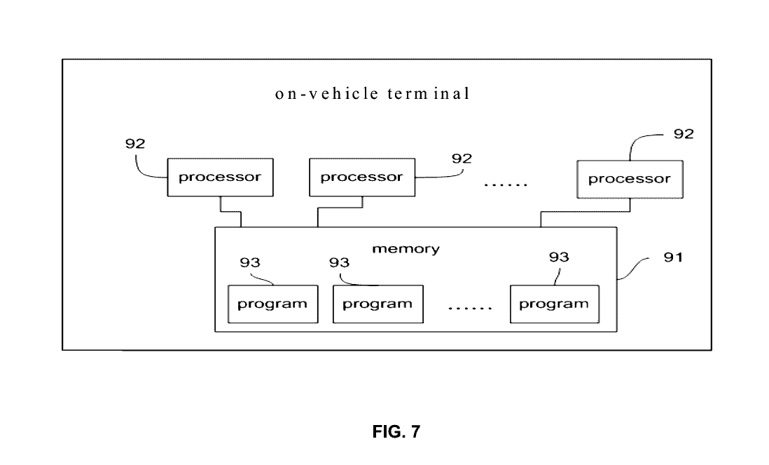

### DETAILED DESCRIPTION

In the following, description will be given in detail on the method and on-vehicle terminal for communication with vehicles in vehicle fleet provided by the embodiments of the present disclosure, in connection with the accompanying drawing.

### First Embodiment

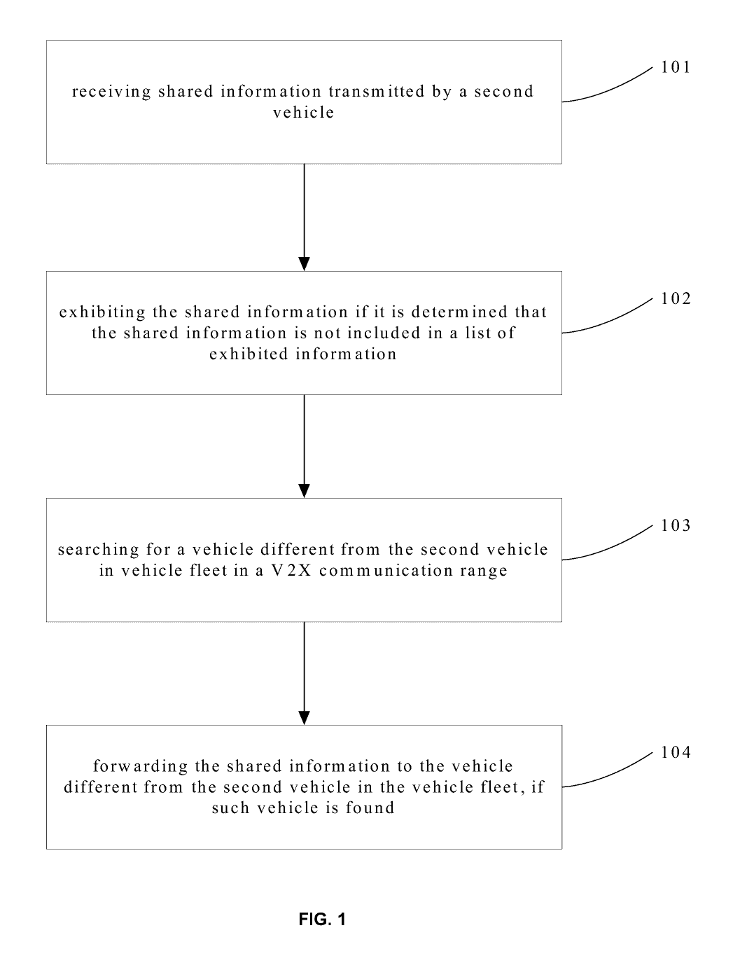

FIG. 1 is a flowchart of a method for communication with vehicles in vehicle fleet provided by the first embodiment of the present disclosure. As shown in FIG. 1, the method provided by the embodiment of the present disclosure may be performed by a first vehicle in vehicle fleet, and may include:

Step 101 of receiving shared information transmitted by a second vehicle.

More particularly, the shared information may include random code, identification and position of the vehicle generating the shared information, and voice and/or data carried therewith. The data may be a speed of the vehicle, a position of the vehicle, and/or remaining gas.

More particularly, when the first vehicle is the receiver of the shared information, the following steps may be performed. The receiver of the shared information is opposite to the transmitter of the shared information, which is a source of the shared information. That is to say, with respect to the same shared information, there is only one receiver of the shared information. In other words, in a vehicle fleet, there is only one vehicle as the transmitter of the shared information and all other vehicles may be as the receiver of the shared information.

Step 102 of exhibiting the shared information if it is determined that the shared information is not included in a list of exhibited information.

More particularly, the first vehicle determines a vehicle icon corresponding to the identification of the vehicle included in the shared information, and the first vehicle may display the vehicle icon in the map based on the position of the vehicle included in the shared information, and may exhibit the shared information.

It should be noted that, the expression “exhibit” or “exhibition” recited in the present embodiment may mean displaying of videos or pictures or texts as well as playing of music.

Step 103 of searching for a vehicle different from the second vehicle in vehicle fleet in a V2X communication range.

More particularly, a list of vehicles in vehicle fleet may be stored in the first vehicle, and may be transmitted to the vehicles in vehicle fleet by a vehicle which is in charge of organizing the vehicle fleet. The first vehicle may search a vehicle different from the second vehicle in the vehicle fleet in a V2X communication range.

Step 104 of forwarding the shared information to the vehicle different from the second vehicle in the vehicle fleet, if such vehicle is found.

Since V2X is a kind of short-distance communication with relative small coverage for communication, it easily happens that the V2X communication range of the second vehicle in vehicle fleet may not cover all vehicles in vehicle fleet, which may easily lead a case that the vehicles out of the V2X communication range of the second vehicle in vehicle fleet may not receive the shared information. Therefore, the first vehicle may forward the shared information transmitted by the second vehicle after receiving it, and thus the possibility for all vehicles in fleet vehicle can receive the shared information may be increased and the sharable range for sharing information may be increased.

To better clarify the procedure for delivering the shared information, the present embodiment provides two possible scenarios:

### The First Scenario

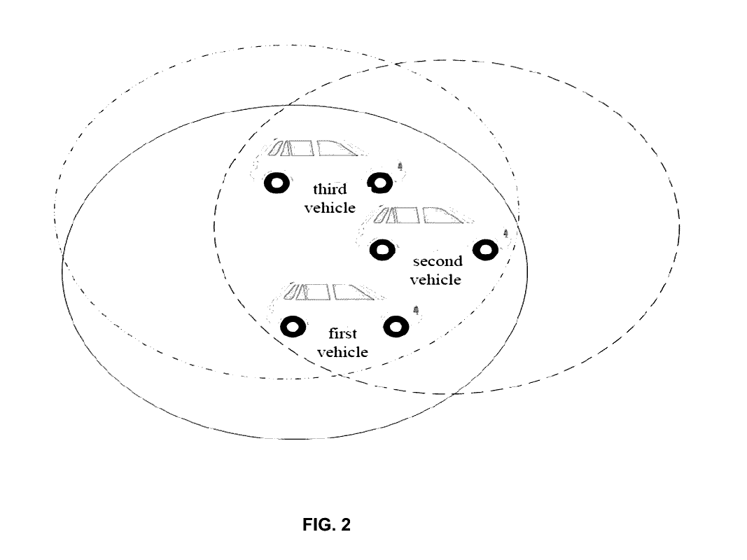

FIG. 2 is a view of a possible relative position relationship view of vehicles in vehicle fleet. As shown in FIG. 2, the V2X communication range of the second vehicle may cover the first vehicle and the third vehicle. Then the second vehicle may transmit the shared information to the first vehicle and the second vehicle directly based on V2X communication. And the first vehicle and the second vehicle may be in the V2X communication range of the other, and the first vehicle may forward the shared information to a third vehicle, while the third vehicle may forward the shared information to the first vehicle. However, the first vehicle and the third vehicle may not exhibit or forward the shared information again, since the first and the third vehicles have received the shared information from the second vehicle and the shared information is included in the list of exhibited information.

### The Second Scenario

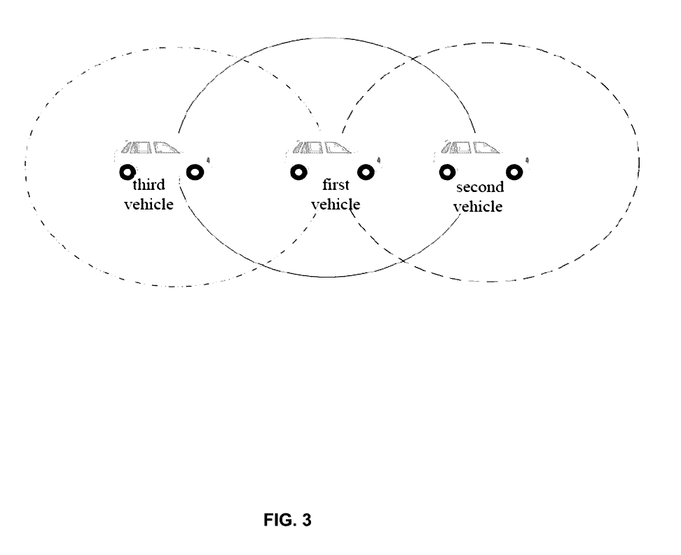

FIG. 3 is a view of another possible relative position relationship view of vehicles in vehicle fleet. As shown in FIG. 3, the V2X communication range of the second vehicle may cover the first vehicle, and the V2X communication range of the first vehicle may cover the third vehicle, but the V2X communication range of the second vehicle may not cover the third vehicle. Then the second vehicle may transmit the shared information to the first vehicle directly based on V2X communication, and the first vehicle may forward the shared information to the third vehicle. The third vehicle may exhibit the shared information since the third vehicle has never received this shared information from the second vehicle.

It should be noted that, in FIG. 2 and FIG. 3, the circle with solid line is the V2X communication range of the first vehicle, the circle with dash line is the V2X communication range of the second vehicle, and the circle with dash dot line is the V2X communication range of the third vehicle.

That is to say, with the method provided by the present embodiment, the sharable range for sharing information may be a union of the V2X communication ranges of respect vehicles changed from an intersection of the V2X communication ranges of respect vehicles.

Furthermore, the method provided by the present embodiment may further include the steps of: generating a shared information carrying voice and/or data by the first vehicle; transmitting the shared information carrying voice and/or data to vehicles in vehicle fleet in the V2X communication range by the first vehicle.

More particularly, when the first vehicle is the transmitter of the shared information, the first vehicle may acquire the voice recorded by the user and/or the data to be shared selected by the user; the first vehicle may generate a random code; the first vehicle may package the voice and/or data and the random code to generate the shared information carrying voice and/or data. The data to be shared selected by the user may be a speed of the vehicle, a position of the vehicle, and/or remaining gas.

Furthermore, before the step 101, the first vehicle may establish a vehicle fleet, which particularly includes the steps of: searching for a second vehicle to be added into a vehicle fleet in the V2X communication range by the first vehicle after receiving an instruction of establishing a vehicle fleet input by a user, and transmitting a request of establishing the vehicle fleet to a second vehicle if the second vehicle is found, the request of establishing the vehicle fleet may include driving information of the first vehicle; receiving a response of establishing the vehicle fleet transmitted by the second vehicle by the first vehicle, the response includes driving information of the second vehicle; exhibiting driving information of the second vehicle and instructing the user to confirm whether or not the second vehicle may be added into the vehicle fleet by the first vehicle; transmitting a confirmation request to the second vehicle to the second vehicle if the first vehicle receives an confirmation to add the second vehicle to the vehicle fleet input by the user; allocating a vehicle icon for the second vehicle and adding the second vehicle to the vehicle fleet when the first vehicle receives the confirmation response transmitted by the second vehicle; the confirmation response is generated after the second vehicle receives the confirmation request, exhibits the driving information of the first vehicle and instructs the user to confirm whether or not to join the vehicle fleet, and receives an instruction of confirming to join the vehicle fleet input by the user; displaying the vehicle icon of the second vehicle and the driving information of the second vehicle on the vehicle fleet interface by the first vehicle.

More particularly, the driving information may include: a plate number, a model, and/or a name of the owner of the vehicle.

More particularly, the step of searching a second vehicle to be added into the vehicle fleet in the V2X communication range may include the steps of searching a second vehicle matched with driving information in the V2X communication range according to the driving information of the vehicle to be added into the vehicle fleet input by the user by the first vehicle, and transmitting a request of establishing a vehicle fleet to the second vehicle via the 3G or 4G network.

Furthermore, after the step 104, if the first vehicle receives an instruction of dismissing the vehicle fleet input by the user, the vehicle icon of the second vehicle and the driving information of the second vehicle displayed on the vehicle fleet interface may be removed.

In the present embodiment, in a vehicle fleet including at least a first, a second, and a third vehicles, the first vehicle may exhibit a shared information if it is confirmed that the shared information is not included in a list of exhibited information, after the first vehicle receives the shared information transmitted by the second vehicle in the vehicle fleet via V2X communication, and the first vehicle further forwards the shared information to the third vehicle, if the first vehicle found the third vehicle different from the second vehicle in the vehicle fleet after searching the third vehicle in a V2X communication range so that the third vehicle may exhibit the shared information. Therefore, the present disclosure may enable the voice or other data and/or information to be shared in the vehicle fleet. In addition, the present disclosure may solve the technical problem that with the manner that members in vehicle fleet may perform voice communication via intercoms, the efficiency of communication may be low due to the fact that only one member can speak at one time by the fact that the V2X communication may receive data while transmitting data.

### Second Embodiment

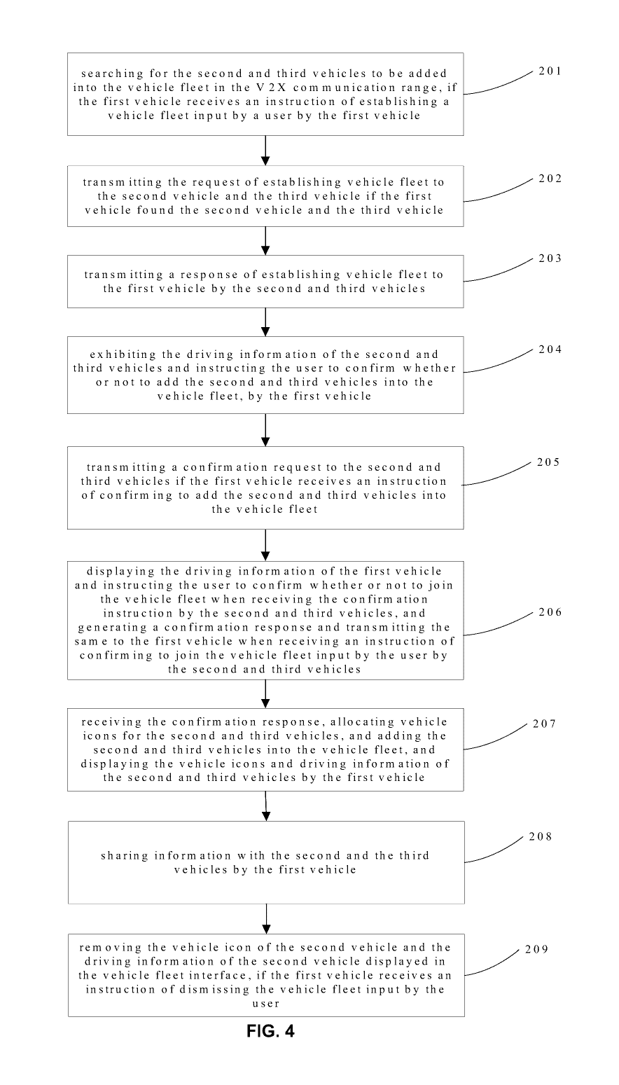

FIG. 4 is a flowchart of another method for communication with vehicles in vehicle fleet provided by the second embodiment of the present disclosure. The method provided by the present embodiment may be performed by an on-vehicle terminal mounted on the first vehicle. As shown in FIG. 4, the vehicle fleet includes at least a first, a second, and a third vehicles.

Step 201, searching for the second and third vehicles to be added into the vehicle fleet in the V2X communication range, if the first vehicle receives an instruction of establishing a vehicle fleet input by a user by the first vehicle.

More particularly, before the establishment of the vehicle fleet, all the vehicles may be gathered at a gathering location, so as to form a vehicle fleet such as a vehicle fleet for self-driving travelling and a vehicle fleet for wedding. First of all, all the vehicles may turn engine on to ensure the working of the on-vehicle terminals and at this moment, the on-vehicle terminal in each vehicle may display position information of the V2X vehicles available for communication around. Then the on-vehicle terminal of one of these vehicles, as the first vehicle, may establish the vehicle fleet and meanwhile include all the related information of the present vehicle, such as a plate number, a model, and a name of the owner of the vehicle (may be set by self) into a request information and transmit the same via a V2X module.

Step 202, transmitting the request of establishing vehicle fleet to the second vehicle and the third vehicle if the first vehicle found the second vehicle and the third vehicle.

The request of establishing vehicle fleet includes the driving information of the first vehicle.

More particularly, related information of the first vehicle, such as a plate number, a model, and a name of the owner of the vehicle into the request of establishing vehicle fleet.

Step 203, transmitting a response of establishing vehicle fleet to the first vehicle by the second and third vehicles.

The response of establishing vehicle fleet may include driving information of the second and third vehicles.

Step 204, exhibiting the driving information of the second and third vehicles and instructing the user to confirm whether or not to add the second and third vehicles into the vehicle fleet, by the first vehicle.

Step 205, transmitting a confirmation request to the second and third vehicles if the first vehicle receives an instruction of confirming to add the second and third vehicles into the vehicle fleet.

Step 206, displaying the driving information of the first vehicle and instructing the user to confirm whether or not to join the vehicle fleet when receiving the confirmation instruction by the second and third vehicles, and generating a confirmation response and transmitting the same to the first vehicle when receiving an instruction of confirming to join the vehicle fleet input by the user by the second and third vehicles.

Step 207, receiving the confirmation response, allocating vehicle icons for the second and third vehicles, and adding the second and third vehicles into the vehicle fleet, and displaying the vehicle icons and driving information of the second and third vehicles by the first vehicle.

More particularly, the first vehicle may add the second and third vehicles to the vehicle list of the vehicle fleet, and transmit the same to the second and third vehicles. The vehicle list of the vehicle fleet may include the driving information and vehicle icons of each vehicle in the vehicle fleet.

Step 208, sharing information with the second and the third vehicles by the first vehicle.

More particularly, the first vehicle may establish a vehicle-fleet link with the second and third vehicles, and then a real-time communication may be performed by turning on a microphone and a speaker. The vehicles having established the vehicle-fleet link may share their internal related information such as positions, information on adjacent vehicles, speed, remaining gas, or remaining electric energy during travelling. Furthermore, if the microphone and speaker of each vehicle are turned on, all the vehicles in the vehicle fleet may perform a real-time communication just like performing a multi-party on-line conference call. When the link between one vehicle and other vehicles in the vehicle fleet is disconnected, i.e., when there is no intersection between the V2X communication ranges of the one vehicle and other vehicles in the vehicle fleet, it is still possible to share its position information in the vehicle fleet via 3G or 4G communication, and display related information in the map of the vehicle fleet while instructing other vehicles in the vehicle fleet that the one vehicle has been out of the effective range. When the one vehicle comes into the effective range, the vehicle-fleet link may be restored.

The detailed procedure for sharing information may refer to the related description to steps 101 to 104 in the first embodiment, and thus may be omitted in the present embodiment to avoid redundancy.

Step 209, removing the vehicle icon of the second vehicle and the driving information of the second vehicle displayed in the vehicle fleet interface, if the first vehicle receives an instruction of dismissing the vehicle fleet input by the user,

More particularly, the first vehicle may dismiss the vehicle fleet established before by pressing a button of “dismissing vehicle fleet” when arriving at the destination. And, at that time, all the vehicles may be not in the vehicle fleet and the information sharing and real-time communication may be terminated automatically. Furthermore, vehicles other than the first vehicle may quit the vehicle fleet by voluntarily press a button of “quit” to quit the vehicle fleet. The driving information of all vehicles which may be included in the vehicle fleet once may be stored in the on-vehicle terminal so as to be input when establishing a vehicle fleet the next time.

In the present embodiment, in a vehicle fleet including at least a first, a second, and a third vehicles, the first vehicle may exhibit a shared information if it is confirmed that the shared information is not included in a list of exhibited information, after the first vehicle receives the shared information transmitted by the second vehicle in the vehicle fleet via V2X communication, and the first vehicle further forwards the shared information to the third vehicle, if the first vehicle found the third vehicle different from the second vehicle in the vehicle fleet after searching the third vehicle in a V2X communication range so that the third vehicle may exhibit the shared information. Therefore, the present disclosure may enable the voice or other data and/or information to be shared in the vehicle fleet. In addition, the present disclosure may solve the technical problem that with the manner that members in vehicle fleet may perform voice communication via intercoms, the efficiency of communication may be low due to the fact that only one member can speak at one time by the fact that the V2X communication may receive data while transmitting data.

### Third Embodiment

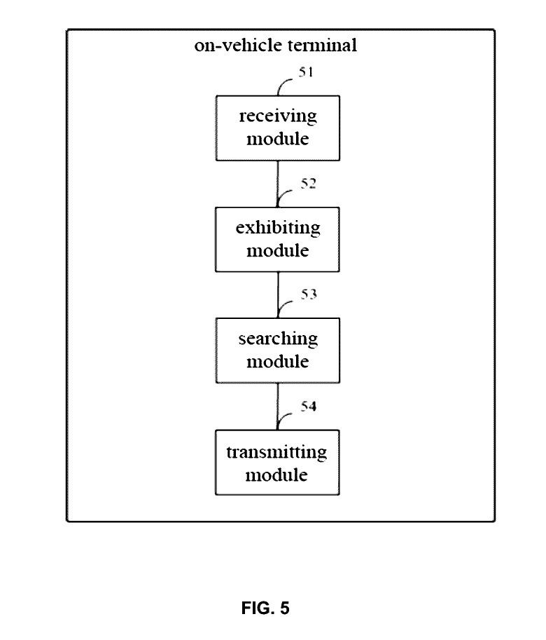

FIG. 5 is a view of the structure of an on-vehicle terminal provided by the third embodiment of the present disclosure. As shown in FIG. 5, the on-vehicle terminal may be mounted on the first vehicle for communication in vehicle fleet. The vehicle fleet may include at least a first vehicle, a second vehicle, and a third vehicle. The on-vehicle terminal may include: a receiving module 51, an exhibiting module 52, a searching module 53, and a transmitting module 54.

The receiving module 51 may be configured to receive shared information transmitted by the second vehicle.

More particularly, the shared information may include random code, identification and position of the vehicle generating the shared information, and voice and/or data carried therewith. The data may be a speed of the vehicle, a position of the vehicle, and/or remaining gas.

The exhibiting module 52 may be connected with the receiving module 51 and configured to exhibit the shared information if it is determined that the shared information is not included in a list of exhibited information.

More particularly, the list of exhibited information may store the random code carried by the exhibited shared information.

The exhibiting module 52 may be further configured to exhibit the shared information if it is determined that the random code carried by the exhibited shared information is not included in a list of exhibited information.

The searching module 53 may be connected with the exhibiting module 52, and configured to searching a vehicle different from the second vehicle in vehicle fleet in a V2X communication range.

The transmitting module 54 may be connected with the searching module 53, and configured to forwarding the shared information to the third vehicle, if the third vehicle is found.

In the present embodiment, in a vehicle fleet including at least a first, a second, and a third vehicles, the first vehicle may exhibit a shared information if it is confirmed that the shared information is not included in a list of exhibited information, after the first vehicle receives the shared information transmitted by the second vehicle in the vehicle fleet via V2X communication, and the first vehicle further forwards the shared information to the third vehicle, if the first vehicle found the third vehicle different from the second vehicle in the vehicle fleet after searching the third vehicle in a V2X communication range so that the third vehicle may exhibit the shared information. Therefore, the present disclosure may enable the voice or other data and/or information to be shared in the vehicle fleet. In addition, the present disclosure may solve the technical problem that with the manner that members in vehicle fleet may perform voice communication via intercoms, the efficiency of communication may be low due to the fact that only one member can speak at one time by the fact that the V2X communication may receive data while transmitting data.

### Fourth Embodiment

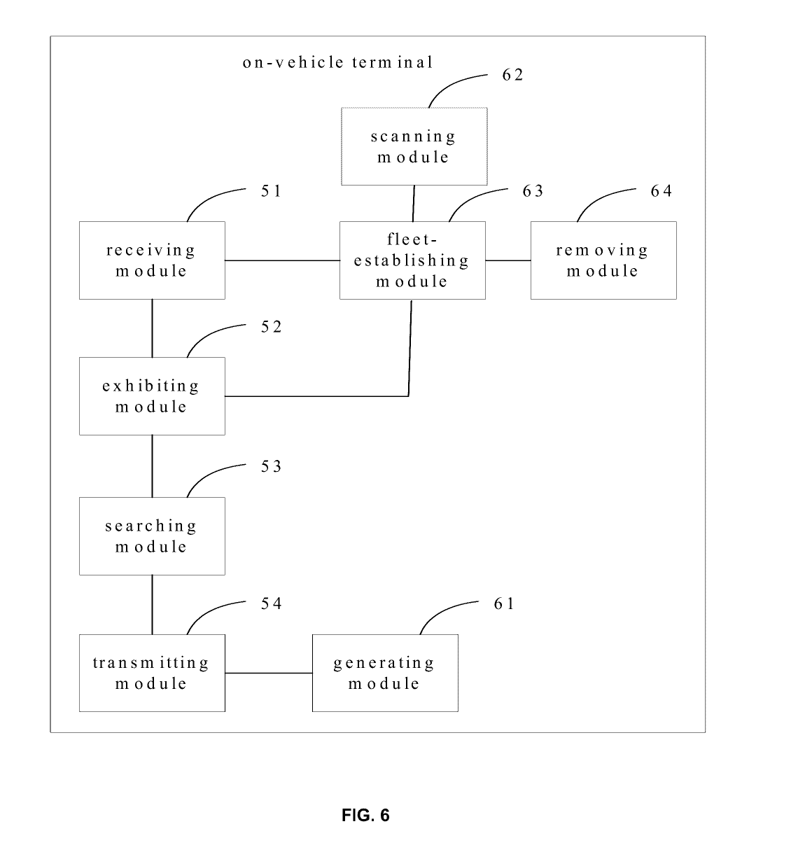

FIG. 6 is a view of the structure of another on-vehicle terminal provided by the fourth embodiment of the present disclosure. As shown in FIG. 6, based on the foregoing embodiment, the on-vehicle terminal in the present embodiment may further include: a generating module 61.

The generating module 61 may be connected with the transmitting module 54 and configured to generate a shared information carrying voice and/or data.

More particularly, the generating module 61 is configured to acquire a voice recorded by a user and/or a data to be shared selected by a user; generate a random code; package the voice and/or data as well as the random code, to generate the shared information carrying the voice or data therewith.

The data to be shared selected by the user may include a speed of the vehicle, a position of the vehicle, and/or remaining gas.

Furthermore, the transmitting module 54 may be further configured to transmit the shared information carrying the voice and/or data therewith to the vehicles in the vehicle fleet in the V2X communication range.

Furthermore, the on-vehicle terminal may further include: a scanning module 62, a fleet-establishing module 63, and a removing module 64.

The scanning module 62 may be configured to search a second vehicle to be added into the vehicle fleet in the V2X communication range if an instruction of establishing a vehicle fleet input by a user is received.

More particularly, the scanning module 62 may be further configured to search a second vehicle matched with driving information in the V2X communication range according to the driving information of the vehicle to be added into the vehicle fleet input by the user.

The fleet-establishing module 63 may be connected with the scanning module 62 and configured to transmit a request of establishing a vehicle fleet to the second vehicle. More particularly, the request of establishing the vehicle fleet may include driving information of the first vehicle. It may be possible to receive a response of establishing the vehicle fleet, which may include the plate number, the model, and/or the name of the owner of the vehicle.

More particularly, the fleet-establishing module 64 may be further configured to transmit a request of establishing the vehicle fleet to the second vehicle via 3G or 4G network, if the second vehicle is not found, and transmit a request of establishing the vehicle fleet to the second vehicle via V2X communication if the second vehicle is found.

The exhibiting module 52 may be further configured to exhibit the driving information of the second vehicle and instruct the user to confirm whether or not to add the second vehicle to the vehicle fleet.

The fleet-establishing module 63 may be further configured to transmit a confirmation request to the second vehicle when an instruction of confirming to add the second vehicle to the vehicle fleet input by the user is received; allocate a vehicle icon to the second vehicle and add the second vehicle to the vehicle fleet when the first vehicle receives the confirmation response transmitted by the second vehicle.

More particularly, the confirmation response is generated after the second vehicle receives the confirmation request, exhibits the driving information of the first vehicle, and instructs the user to confirm whether or not to join the vehicle fleet, and receives the instruction of confirming to join the vehicle fleet input by the user.

The exhibiting module 52 may be further configured to display the vehicle icon of the second vehicle and the driving information of the second vehicle on the vehicle interface.

The removing module 64 may be connected with the fleet-establishing module 63 and may be configured to remove the vehicle icon of the second vehicle and the driving information of the second vehicle displayed on the vehicle interface if the first vehicle receives the instruction of dismissing the vehicle fleet input by the user.

It should be noted that, the device provided by the present embodiment may be configured to perform the method provided by the foregoing first and second embodiments. The respect function module of the device in the present embodiment may refer to the related description in the foregoing method embodiments, and thus may be omitted in the present embodiment to avoid redundancy.

In the present embodiment, in a vehicle fleet including at least a first, a second, and a third vehicles, the first vehicle may exhibit a shared information if it is confirmed that the shared information is not included in a list of exhibited information, after the first vehicle receives the shared information transmitted by the second vehicle in the vehicle fleet via V2X communication, and the first vehicle further forwards the shared information to the third vehicle, if the first vehicle found the third vehicle different from the second vehicle in the vehicle fleet after searching the third vehicle in a V2X communication range so that the third vehicle may exhibit the shared information. Therefore, the present disclosure may enable the voice or other data and/or information to be shared in the vehicle fleet. In addition, the present disclosure may solve the technical problem that with the manner that members in vehicle fleet may perform voice communication via intercoms, the efficiency of communication may be low due to the fact that only one member can speak at one time by the fact that the V2X communication may receive data while transmitting data.

One skilled in the art would appreciate that all or a part of the steps for implementing the foregoing method embodiments may be implemented by hardware related to program instructions. Foregoing programs may be stored in computer-readable storage medium, and upon being executed, such programs may perform the steps including foregoing method embodiments; and examples of foregoing storage medium include ROM, RAM, CD-ROM, a magnetic tape, the other types of storage mediums which may store the program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

What is claimed is:

1. A method for communicating with vehicles in a vehicle fleet, which is applied to a first vehicle in the vehicle fleet, comprising:
receiving shared information transmitted by a second vehicle in the vehicle fleet;
exhibiting the shared information and adding the shared information to a list of exhibited information, if it is determined that the shared information is not included in the list of exhibited information;
searching for a vehicle different from the second vehicle in the vehicle fleet in a V2X (Vehicle to X) communication range; and
forwarding the shared information to the vehicle different from the second vehicle in the vehicle fleet, if the vehicle different from the second vehicle in the vehicle fleet is found.

2. The method for communicating with vehicles in a vehicle fleet according to claim 1, further comprising:
generating shared information carrying voice and/or data therewith; and
transmitting the shared information carrying voice and/or data therewith to the vehicles in the vehicle fleet in the V2X communication range.

3. The method for communicating with vehicles in a vehicle fleet according to claim 2, wherein the generating shared information carrying voice and/or data therewith further comprises:
acquiring voice recorded by a user and/or data to be shared selected by a user;
generating a random code; and
packaging voice and/or data, as well as the random code to generate the shared information carrying voice and/or data therewith.

4. The method for communicating with vehicles in a vehicle fleet according to claim 3, wherein the list of exhibited information stores the random codes carried by the exhibited shared information, and
the determining that the shared information is not included in the list of exhibited information comprises: determining that the random code carried by the exhibited shared information is not included in the list of exhibited information.

5. The method for communicating with vehicles in a vehicle fleet according to claim 3, wherein the data to be shared selected by the user comprises: the speed of the vehicle, the position of the vehicle and/or remaining gas.

6. The method for communicating with vehicles in a vehicle fleet according to claim 1, wherein the shared information comprises an identification and position of the vehicle generating the shared information, and the exhibiting the shared information comprises:
determining a vehicle icon corresponding to the identification of the vehicle in the shared information; and
displaying the vehicle icon in a map and exhibiting the shared information according to the position of the vehicle in the shared information.

7. The method for communicating with vehicles in a vehicle fleet according to claim 1, wherein before the receiving the shared information transmitted by the second vehicle, the method further comprises:
searching for a second vehicle to be added into the vehicle fleet in the V2X communication range, if an instruction of establishing the vehicle fleet input by a user is received;
transmitting a request of establishing the vehicle fleet to a second vehicle if the second vehicle is found, wherein the request of establishing the vehicle fleet comprises driving information of the first vehicle;
receiving a response of establishing the vehicle fleet transmitted by the second vehicle, the response comprising driving information of the second vehicle;
exhibiting the driving information of the second vehicle and instructing the user to confirm whether or not to add the second vehicle to the vehicle fleet;
transmitting a confirmation request to the second vehicle if an instruction of confirming to add the second vehicle into the vehicle fleet input by the user is received;
allocating a vehicle icon to the second vehicle and adding the second vehicle to the vehicle fleet when the confirmation response transmitted by the second vehicle is received, wherein the confirmation response is generated after the second vehicle receives the confirmation request, displays the driving information of the first vehicle and instructs the user to confirm whether or not to join the vehicle fleet, and receives an instruction of joining the vehicle fleet input by the user; and
displaying the vehicle icon of the second vehicle and the driving information of the second vehicle on an interface of the vehicle fleet.

8. The method for communicating with vehicles in a vehicle fleet according to claim 7, wherein the driving information comprises a plate number, a model, and/or a name of the owner of the vehicle.

9. The method for communicating with vehicles in a vehicle fleet according to claim 7, wherein the searching for a second vehicle to be added into a vehicle fleet in the V2X communication range comprises:
searching for a second vehicle matched with driving information in the V2X communication range according to the driving information of the vehicle to be added into the vehicle fleet input by the user.

10. The method for communicating with vehicles in a vehicle fleet according to claim 9, wherein the transmitting a request of establishing a vehicle fleet to the second vehicle comprises:
transmitting a request of establishing a vehicle fleet to the second vehicle via 3G or 4G network, if the second vehicle is not found.

11. The method for communicating with vehicles in a vehicle fleet according to claim 7, wherein after the displaying the vehicle icon of the second vehicle and the driving information of the second vehicle on the vehicle fleet interface, the method further comprises:
removing the vehicle icon of the second vehicle and the of the second vehicle displayed on the vehicle fleet interface if an instruction of dismissing the vehicle fleet input by the user is received.

12. An on-vehicle terminal, which is mounted on a first vehicle in the vehicle fleet, and is configured to perform communication between the first vehicle and other vehicles in the vehicle fleet, comprising:
one or more processors;
a memory; and
one or more programs stored in the memory and configured to perform operations when executed by the one or more processors, wherein the operations comprise:
receiving shared information transmitted by a second vehicle in the vehicle fleet;
exhibiting the shared information and adding the shared information to a list of exhibited information, if it is determined that the shared information is not included in the list of exhibited information;
searching for a vehicle different from the second vehicle in the vehicle fleet in a V2X (Vehicle to X) communication range; and
forwarding the shared information to the vehicle different from the second vehicle in the vehicle fleet, if the vehicle different from the second vehicle in the vehicle fleet is found.

13. The on-vehicle terminal according to claim 12, wherein the operations further comprise:
generating shared information carrying voice and/or data therewith; and
transmitting the shared information carrying voice and/or data therewith to the vehicles in the vehicle fleet in the V2X communication range.

14. The on-vehicle terminal according to claim 13, wherein the operations further comprise:
acquiring voice recorded by a user and/or data to be shared selected by a user;
generating a random code; and
packaging voice and/or data, as well as the random code to generate the shared information carrying voice and/or data therewith.

15. The on-vehicle terminal according to claim 13, wherein the list of exhibited information stores the random codes carried by the exhibited shared information, and the determining that the shared information is not included in the list of exhibited information comprises: determining that the random code carried by the exhibited shared information is not included in the list of exhibited information.

16. The on-vehicle terminal according to claim 12, wherein the shared information comprises identification and position of the vehicle generating the shared information, and the exhibiting the shared information comprises:
determining a vehicle icon corresponding to the identification of the vehicle in the shared information; and
displaying the vehicle icon in a map and exhibiting the shared information according to the position of the vehicle in the shared information.

17. The on-vehicle terminal according to claim 12, wherein before the receiving the shared information transmitted by the second vehicle, the operations further comprise:
searching for a second vehicle to be added into the vehicle fleet in the V2X communication range, if an instruction of establishing the vehicle fleet input by a user is received;
transmitting a request of establishing the vehicle fleet to a second vehicle if the second vehicle is found, wherein the request of establishing the vehicle fleet comprises driving information of the first vehicle;
receiving a response of establishing the vehicle fleet transmitted by the second vehicle, the response comprising driving information of the second vehicle;
exhibiting the driving information of the second vehicle and instructing the user to confirm whether or not to add the second vehicle to the vehicle fleet;
transmitting a confirmation request to the second vehicle if an instruction of confirming to add the second vehicle into the vehicle fleet input by the user is received;
allocating a vehicle icon to the second vehicle and adding the second vehicle to the vehicle fleet when the confirmation response transmitted by the second vehicle is received, wherein the confirmation response is generated after the second vehicle receives the confirmation request, displays the driving information of the first vehicle and instructs the user to confirm whether or not to join the vehicle fleet, and receives an instruction of joining the vehicle fleet input by the user; and
displaying the vehicle icon of the second vehicle and the driving information of the second vehicle on an interface of the vehicle fleet.

18. The on-vehicle terminal according to claim 17, wherein the searching for a second vehicle to be added into a vehicle fleet in the V2X communication range comprises:
searching for a second vehicle matched with driving information in the V2X communication range according to the driving information of the vehicle to be added into the vehicle fleet input by the user.

19. The on-vehicle terminal according to claim 17, wherein the transmitting a request of establishing a vehicle fleet to the second vehicle comprises:
transmitting a request of establishing a vehicle fleet to the second vehicle via 3G or 4G network, if the second vehicle is not found.

20. The on-vehicle terminal according to claim 17, wherein after the displaying the vehicle icon of the second vehicle and the driving information of the second vehicle on the vehicle fleet interface, the operations further comprise:
removing the vehicle icon of the second vehicle and the driving information of the second vehicle displayed on the vehicle fleet interface if an instruction of dismissing the vehicle fleet input by the user is received.
